(19) United States
(12) Patent Application Publication
(10) Pub. No.: US 2006/0080439 A1
(43) Pub. Date: Apr. 13, 2006

(54) Method and system for reducing bandwidth needed to filter requested content

(76) Inventors: Andrew Chud, Dallas, TX (US); Trey Ballard, Dallas, TX (US); Pulin Chhatbar, Plano, TX (US)

Correspondence Address: DUKE W. YEE, YEE & ASSOCIATES, P.C., P.O. BOX 802333, DALLAS, TX, 75380, US

(21) Appl. No.: 11/235,055

(22) Filed: Sep. 26, 2005

Related U.S. Application Data
(60) Provisional application No. 60/618,216, filed on Oct. 13, 2004.

(51) Int. Cl. G06F 15/173

(52) U.S. Cl. 709/225

(57) ABSTRACT

A method and system uses an improved protocol in content request filtering, in connection with a Content Filter Server and a Content Filter Client. The number and size of messages defined by the protocol is comparatively small, to achieve significant reduction in bandwidth requirements. In one useful embodiment, wherein a requester submits a request to access content at one or more sites of a network, a method is provided for content filtering. The method includes the step of sending a Content Decision Request, that contains one or more first information elements and is limited to a single second information element, from a first location to a Content Filter Server. Each of the first information elements uniquely identifies the location of one of the requested content sites, and the second element comprises an identifier uniquely identifying the requester. The method further includes selectively processing specified variable inputs at the Content Filter Server, to decide whether to allow or deny access to each of the requested content sites by the requester, wherein the specified variable inputs are limited to the one or more first information elements and the single second information element.

### CROSS-REFERENCE TO RELATED APPLICATIONS

Pursuant to 35 U.S.C. §119(e), this application claims the benefit of U.S. Provisional Patent Application Ser. No. 60/618,216, entitled Lightweight Protocol for External HTTP/WAP Content Filtering, filed Oct. 13, 2004, and named Andrew Chud, Trey Ballard and Pulin Chhatbar as inventors, which is hereby incorporated by reference for all purposes.

### 1. FIELD OF THE INVENTION

The invention disclosed and claimed herein generally pertains to a method and system for filtering requested content, whereby a request to access specific content at a web site or other location is allowed, denied or otherwise resolved. More particularly, the invention pertains to a method of the above type wherein required bandwidth, for communication between a network gateway and a content filter server in resolving the request, may be substantially reduced. Even more particularly, the invention pertains to a method of the above type wherein such communication may be limited to comparatively short request and response messages.

### 2. BACKGROUND OF THE INVENTION

In the operation and use of interconnected networks such as the Internet, different types of requesters continually seek access to content located at diverse network sites and locations, usefully identified by URLs. As a result, it has become necessary to develop tools for controlling access to the requested content, by determining whether respective requests should be allowed or denied. The widespread use of wireless phones and other wireless communication devices has further increased the need for content access control mechanisms.

Currently, a device known as a Content Filter Server (CFS) is used for content access control. A CFS is configured to perform the task of deciding whether to approve, deny, or redirect respective content requests. Herein, a Content Filter Server is referred to as an HTTP/WAP Content Filter Server, if it can support both Hypertext Transport Protocol (HTTP) and Wireless Access Protocol (WAP) content requests. The term “HTTP/WAP request” is used herein to refer to the original request of a subscriber or other requester to access content at one or more locations or URL sites.

A CFS generally makes its decision based on the nature of the requested content, and also on the identity of the requester. For example, the CFS may recognize that a requester using a mobile phone is a minor, based on the identity code of the mobile phone. Accordingly, the CFS would not allow the requester to access any requested adult content. As another example, the content being requested could be proprietary to a particular business organization. The CFS would allow access to this content to a requestor only after determining that the requestor was properly authorized to have access.

In a common arrangement, a gateway node in a packet network functions as an HTTP/WAP Content Filter Client, and may use a suitable protocol to interact with the HTTP/WAP CFS. Initially, the Client intercepts the packet for either an HTTP or WAP request. The packet would be a TCP packet for an HTTP request, and would be a UDP packet for a WAP request. The Client is then responsible for checking with the CFS, before allowing the request to continue on from the Content Filter Client to a content server, such as an HTTP server or a WAP gateway, which provides access to the content. As noted above, the Content Filter Server will make one of three decisions, to either allow the content request, deny the content request or direct the request elsewhere.

In an arrangement of the above type, a standard protocol that is currently available for use in routing requests and related messages between a Content Filter Client and Content Filter Server is the Internet Content Adaptation Protocol (ICAP). ICAP, however, tends to use excessive bandwidth. ICAP is defined so that an entire HTTP request received by the Client is sent to the CFS. Subsequently, the entire modified HTTP request is sent back to the Client. Also, ICAP has the ability to perform complete content adaptations or translations of routed messages, but this capability is not pertinent to content filtering. Moreover, ICAP supports HTTP only, and not WAP. Therefore, it would be very beneficial to provide an efficient lightweight protocol for use in filtering both HTTP and WAP content requests. The protocol could then be used to transport messages between an HTTP/WAP Content Filter Client and an HTTP/WAP Content Filter Server. Efficiency would be enhanced by limiting protocol functions only to those necessary for content filtering.

### SUMMARY OF THE INVENTION

The invention generally provides an improved protocol for use in content request filtering, in a system using an HTTP/WAP Content Filter Server and an associated HTTP/WAP Content Filter Client, as described above. The protocol of the invention encodes and decodes preferably binary messages, wherein the messages are to be sent over TCP and UDP connections, selectively, between the Client and CFS. The number and size of messages defined by the protocol is comparatively small, to achieve significant reduction in bandwidth requirements. System capacity and performance are thereby increased, and filtering efficiency is enhanced for HTTP/WAP requests. In one useful embodiment of the invention, wherein a requester submits a request to access content at one or more sites of a network, a method is provided for content filtering. The method includes the step of sending a Content Decision Request, that contains one or more first information elements and is limited to a single second information element, from a first location to a Content Filter Server. Each of the first information elements uniquely identifies the location of one of the requested content sites, and the second element comprises an identifier uniquely identifying the requestor. The method further includes selectively processing specified variable inputs at the Content Filter Server, to decide whether to allow or deny access to each of the requested content sites by the requester, wherein the specified variable inputs are limited to the one or more first information elements and the single second information element.

### BRIEF DESCRIPTION OF THE DRAWINGS

FIG. 1 is a schematic diagram depicting a configuration of interconnected networks, including the Internet, in which an embodiment of the invention is implemented.

FIG. 2 is a block diagram showing a Content Filter Server for use in the network configuration of FIG. 1.

FIG. 3 is a block diagram showing a content filter client, or gateway node, for the network configuration of FIG. 1.

FIG. 4 is a schematic diagram showing the GGSN of FIG. 1 in further detail.

FIG. 5 depicts a format for a header for respective messages to be used in an embodiment of the invention.

FIGS. 6-9 depict formats for Options Request, Options Response, Content Decision Request, and Content Decision Response messages, respectively, for an embodiment of the invention.

FIG. 10 is a flow chart further illustrating a requested content filtering procedure, in accordance with an embodiment of the invention.

FIG. 11 is a set of sequence diagrams illustrating routing of messages in an embodiment of the invention.

### DETAILED DESCRIPTION OF THE PREFERRED EMBODIMENT

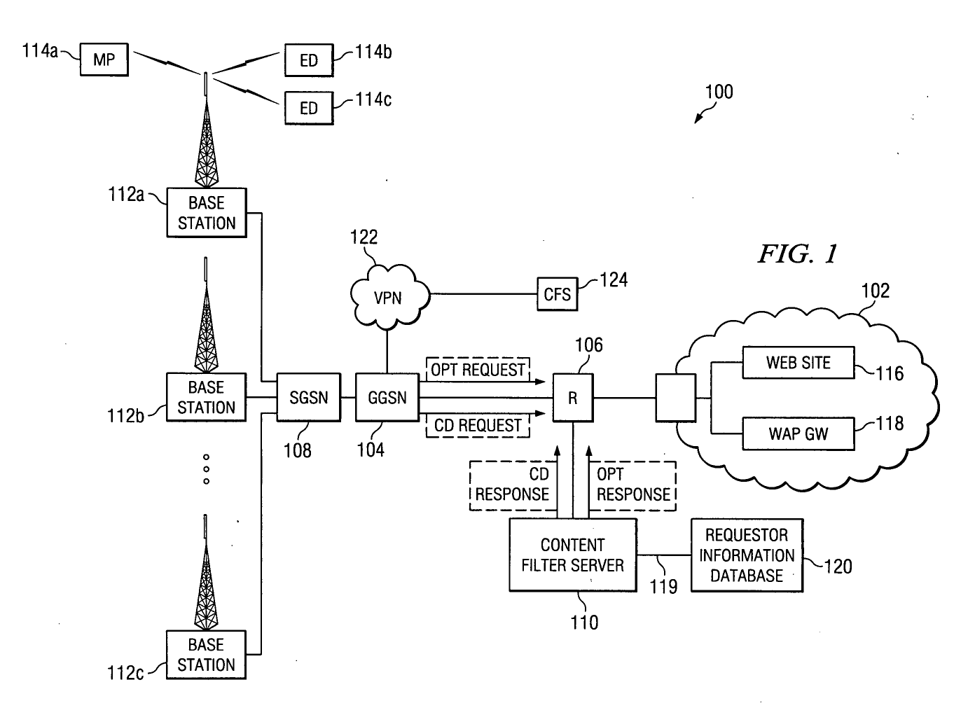

Referring to FIG. 1, there is shown a configuration of interconnected networks 100 that includes Internet 102. The network configuration 100 further includes a gateway node 104, known as a Gateway GPRS Support Node (GGSN), connected to Internet 102 through a router 106. As is well known, GPRS is an acronym for “General Packet Radio Service”. GGSN 104 is also connected by means of router 106 to a Content Filter Server (CFS) 110, which usefully comprises a Content Filter Server that has been adapted in accordance with an embodiment of the invention.

FIG. 1 further shows GGSN 104 connected to a Serving GPRS Support Node (SGSN) 108, by means of a link using GPRS Tunneling Protocol (GTP). SGSN 108 is coupled to exchange information signals with base stations 112a-c of a standard wireless communication network. Each base station provides a communication link between SGSN 108 and wireless communication devices 114a-c, such as a mobile phone 114a and other electronic devices such as PDAs or wireless computers.

It is thus seen from FIG. 1 that GGSN 104 can receive information from and send information to wireless devices such as 114a-c. The GGSN can exchange messages with the mobile via the UMTS or GPRS access network. As far as the mobile is aware, it is communicating with a WAP gateway or HTTP server (web server), though the traffic is really intercepted by the GGSN. Accordingly, GGSN 104 is available to act as a gateway for users of wireless devices 114a-c, who seek to access content through Internet 102. For example, a user of mobile phone 114a may seek to access content located at a website 116 of Internet 102. Alternatively, a user could seek content by establishing a path through Internet 102 to WAP gateway 118 or the like. GGSN 104 is adapted to intercept this traffic for content filtering.

As discussed above, certain content is to be made available to some requesters but not to others. Accordingly, Content Filter Server 110 is provided to decide how each request for content should be handled. More particularly, when a specific HTTP/WAP request is received at GGSN 104, to access content at a specified web site or other location, a series of messages are exchanged between GGSN 104 and Content Filter Server 110. A protocol defined in accordance with an embodiment of the invention is used for these messages.

In a very useful embodiment, the protocol limits the messages to four different message types. These include Options Request and Content Decision Request messages, sent from GGSN 104 to CFS 110, and Options Response and Content Decision Response messages, sent from CFS 110 to GGSN 104. Using only four types of messages is very helpful in reducing bandwidth requirements. Each of these message types is described hereinafter, in further detail.

For a specific HTTP/WAP content request directed to content at a particular site, the Content Filter Server 110 will either, (1) allow the request, (2) deny the request, or (3) instruct the GGSN 104 to redirect the request to an Internet site or location different from the particular requested site. In reaching a decision regarding a specific request, Content Filter Server 110 may access, by means of a suitable link 119, a database 120 containing information that pertains to the requestor of the content. One such database 120 could, for example, be a database accessible by means of the RADIUS protocol. This protocol is conventionally available to enable remote access servers to communicate with a central server to authenticate dial-in users and authorize their access to a requested system or service.

Referring further to FIG. 1, there is shown GGSN 104 additionally connected to a virtual private network (VPN) 122. The VPN 122 represents one of a number of networks, in addition to the Internet, at which sites containing requested content may be located. Accordingly, a CFS 124 is connected to VPN 122, to initially receive all content requests sent to GGSN 104 that are directed to sites at VPN 122. CFS 124 operates in like manner with Content Filter Server 110, to decide whether to allow, deny or redirect each of such requests.

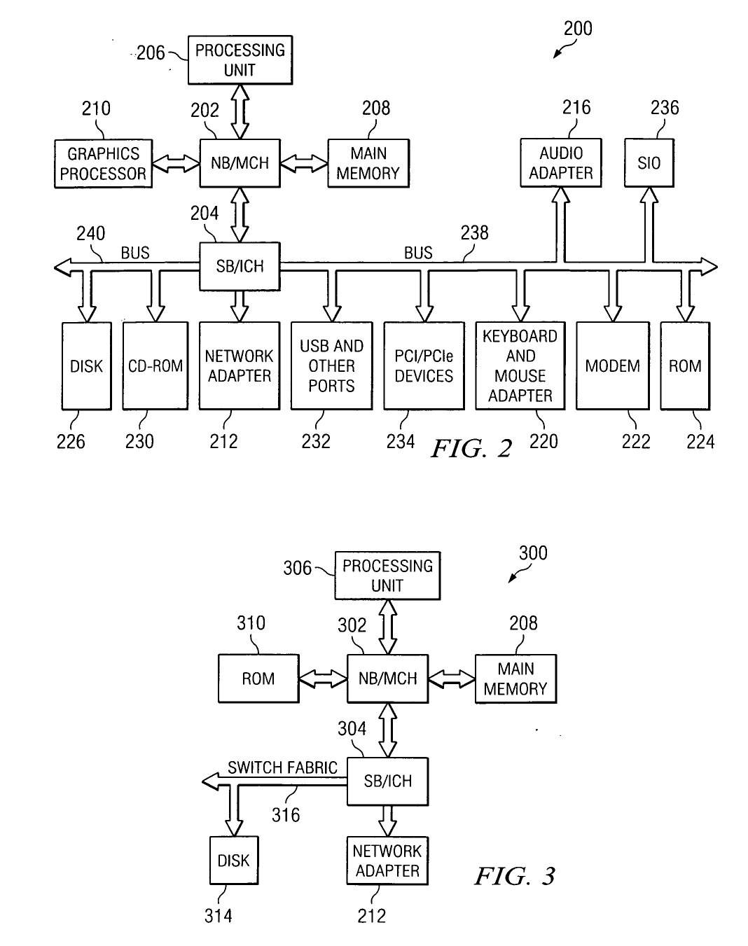

Referring to FIG. 2, there is shown a block diagram of a data processing system 200 in which aspects of the present invention may be implemented. More particularly, data processing system 200 is an example of a computer which may be employed as Content Filter Server 110 in FIG. 1, and in which computer usable code or instructions implementing processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2.

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIG. 2 may vary depending on the implementation. Other internal hardware or peripheral devices may be used in addition to or in place of the hardware depicted in FIG. 2.

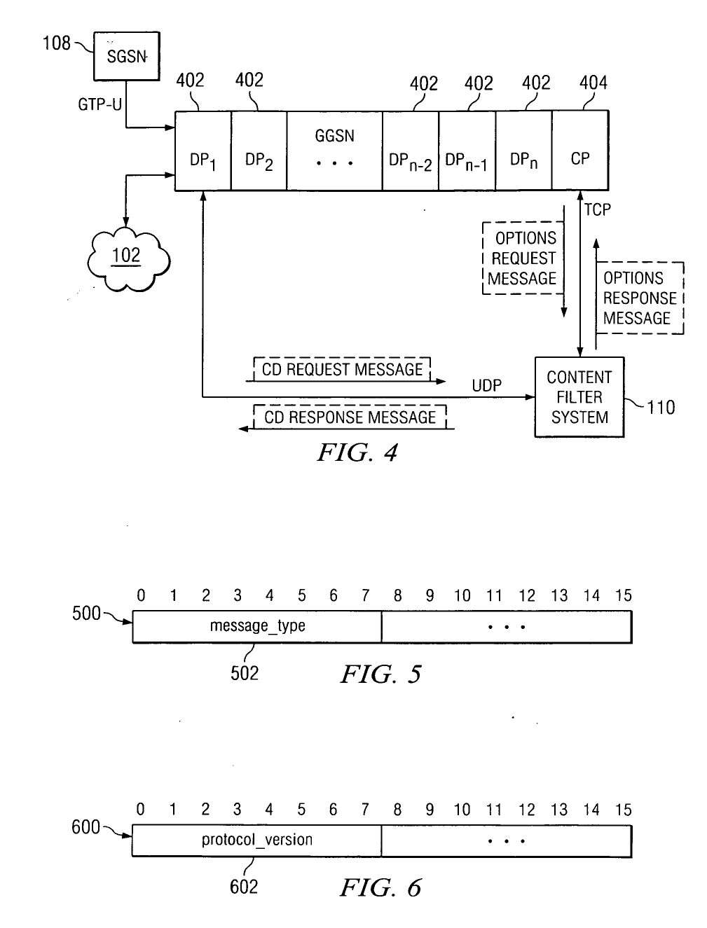

Referring to FIG. 3, there is shown a block diagram of a data processing system 300 which is an example of a computer which may be employed in GGSN 104 in FIG. 1, and in which computer usable code or instructions implementing processes for embodiments of the present invention may be located.

In the depicted example, data processing system 300 employs a hub architecture including north bridge and memory controller hub (MCH) 302 and south bridge and input/output (I/O) controller hub (ICH) 304. Processing unit 306, main memory 308, and read only memory (ROM) 310 are connected to north bridge and memory controller hub 302. In the depicted example, local area network (LAN) adapter 312 connects to south bridge and I/O controller hub 304. Hard disk drive (HDD) 314 connects to south bridge and I/O controller hub 304 through a switch fabric 316. Hard disk drive 314 may use, for example, an integrated drive electronics (IDE) or serial advanced technology attachment (SATA) interface.

An operating system runs on processing unit 306 and coordinates and provides control of various components within data processing system 300 in FIG. 3.

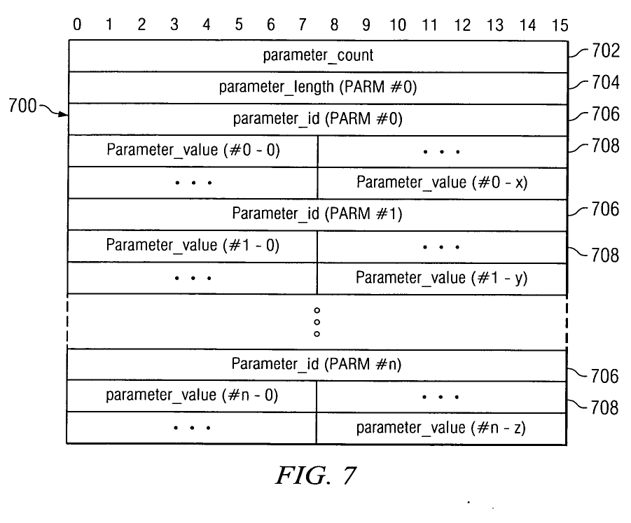

Referring to FIG. 4, there is shown an embodiment of the invention wherein GGSN 104 comprises n data plane processors 402, respectively referenced as DP₁-DPₙ. Each data plane processor 402 is connected to exchange user data with SGSN 104, over a link using GTP-U protocol. Each data plane is also coupled to Internet 102. FIG. 4 further shows GGSN 104 provided with a control plane processor or controller 404, for handling all control functions for GGSN 104. Usefully, GGSN 104 includes n instances of data processing system 300 shown in FIG. 3, one for each of the data plane processors DP₁-DPₙ. GGSN 104 further includes two instances of system 300, one for control plane processor 404 and another as a redundant control plane processor (not shown).

As stated above, a protocol in accordance with the invention can be limited to four types of messages, including an Options Request and an Options Response. As an initial step, when GGSN 104 is first connected to Content Filter Server 110, control plane processor 404 sends an Options Request message to CFS 110. This message is used to negotiate options with the Content Filter Server, such as protocol version and product identification. Then, in response to the Options Request, Content Filter Server 110 sends an Options Response message back to control plane processor 404. This message confirms to GGSN 104 that a connection has in fact been established between GGSN 104 and CFS 110.

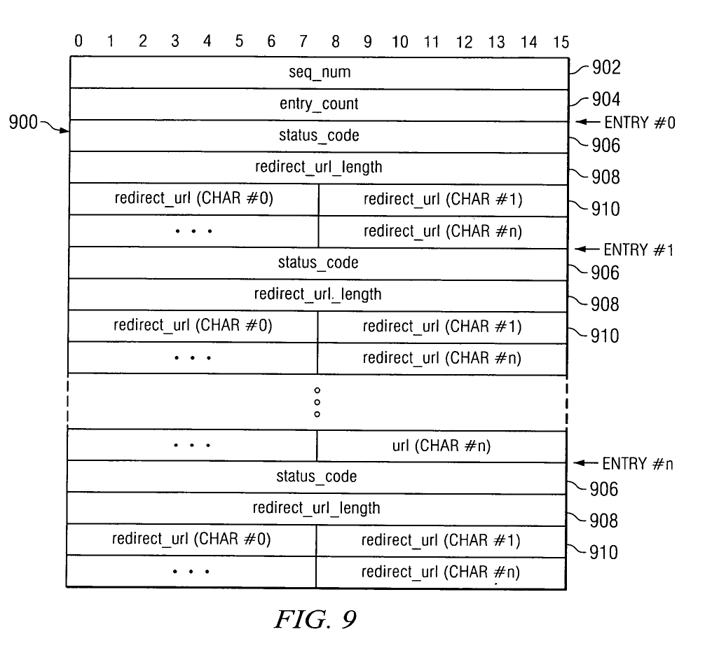

Both the Options Request and Options Response messages are routed by means of a TCP connection. The formats of these messages are described hereinafter in further detail, in connection with FIGS. 6 and 7, respectively. After the connection between GGSN 104 and CFS 110 has been established and confirmed, these two types of messages do not need to be used further.

Referring further to FIG. 4, when a subscriber request to access content at a specified web site is routed to GGSN 104 from SGSN 108, the request is received at one of the data planes 402, such as DP₁. The data plane intercepts the request, and then routes a Content Decision Request message to CFS 110. The Content Decision Request pertains to the intercepted content access request, and is routed to CFS 110 by means of UDP. In response to the Content Decision Request, CFS 110 decides whether to allow, deny or redirect the content access request. A Content Decision Response message, setting forth this decision, is then sent back to data plane DP₁ of GGSN 104, again using UDP. The formats for the Content Decision Request and Content Decision Response messages are described hereinafter in further detail, in connection with FIGS. 8 and 9, respectively.

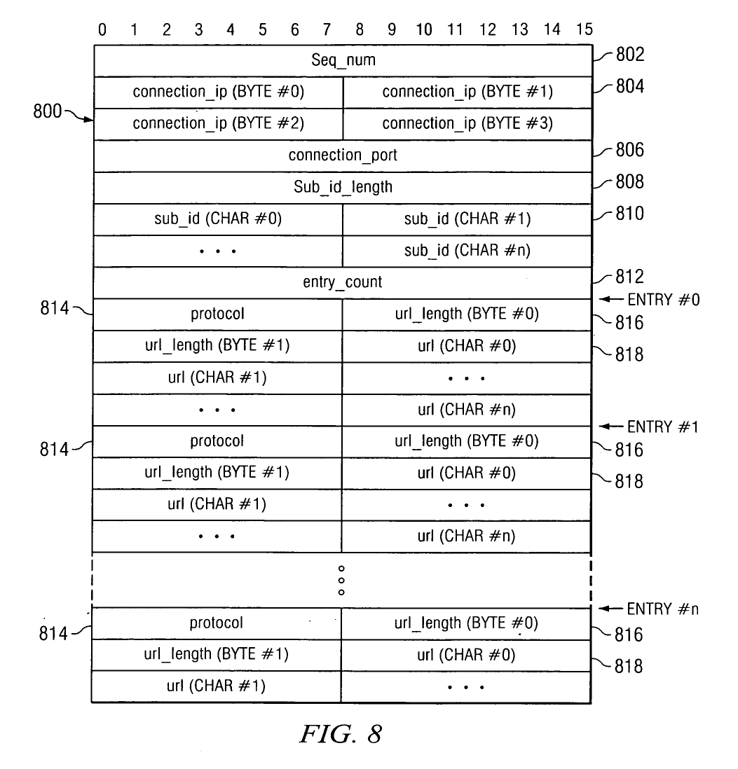

Referring to FIG. 5, there is shown a common header 500, which is contained in messages of all four of the above types in accordance with the protocol of the invention. The header includes a 1-byte field 502 that identifies the particular message type. While not shown, each message of the response message types additionally contains a 2-byte parameter known as a header status code.

Referring to FIG. 6, there is shown the format for an Options Request message 600. As stated above, when GGSN 104 and CFS 110 are first connected, GGSN 104 sends a message 600 to the Content Filter Server 110. The message 600 is used to negotiate options with Content Filter Server 110, such as protocol version and product identification. The message 600 contains a field for a 1-byte protocol version parameter 602. Preferably, after the Options Request message 600 has been responded to, using TCP, further messages exchanged between GGSN 104 and Content Filter Server 110 will use User Datagram Protocol (UDP). UDP is used rather than TCP for transporting messages. This provides certain benefits, such as making it unnecessary to pass a high volume of requests/responses through a finite set of TCP connections.

Referring to FIG. 7, there is shown the format for an Options Response message 700, of the type sent from CFS 110 to the GGSN 104 in response to an Options Request message. Message 700 contains respective parameters 702-708, directly following the common response header. The header status code for an Options Response message 700, referred to above, may contain one of three response codes. These codes respectively indicate that the previous corresponding options request message is okay; is bad; or the protocol version specified in the corresponding options request message is not supported.

Referring further to FIG. 7, parameter 702 provides a count of parameters that follow. Parameter 704 provides the length of a specific parameter in bytes, and parameter 706 provides the identifier for a specific parameter. Each parameter value 708 provides a string parameter value. This parameter value could, for example, identify a particular type of content filter server that was being used for Content Filter Server 110.

Referring to FIG. 8, there is shown the format for a Content Decision Request message 800. Message 800 contains a number of parameters that directly follow the common header 300 discussed above, including parameters 802-818. As stated above, a message of this type is sent from GGSN 104 to CFS 110 after GGSN 104 has received a content access request, such as from SGSN 108. As an important feature of embodiments of the invention, a Content Decision Request message 800 will generally transport two principal types of information elements to Content Filter Server 110. This feature tends to enhance efficiency of operation, and further reduces bandwidth requirements. One of the information element types is a unique identity of the original requester, also referred to as a subscriber. The other type of information element is an address, or other unique location identifier, for each site containing content that is listed in the HTTP/WAP request. In a very useful embodiment, this type of information element comprises a Uniform Resource Locator (URL) indicating a requested site.

Typically, there will only be one requester or subscriber associated with an HTTP/WAP request for content. However, while an HTTP/WAP request will always contain at least one entry, to access content at a particular site, the request could alternatively include multiple entries, each seeking to access content at a different location. For example, GGSN 104 could receive a pipelined HTTP/WAP request, which sought to access content at multiple URL locations, with one entry per requested URL. To accommodate this situation, the protocol of the invention is configured to allow Content Decision Request message 800 to contain multiple information elements of the second type. Each such information element corresponds to an entry requesting access to content at a different URL. By furnishing Content Filter Server 110 with such multiple requested entries in a single Request message 800, efficiency can be significantly enhanced. Content Filter Server 110 is thereby enabled to process all the entries as a single batch, in deciding how to respond to each individual URL request.

Referring further to FIG. 8, there is shown parameter 802 comprising a sequence number, which is used to correlate requests and responses. Parameters 804 and 806 respectively provide the destination IP address and destination port number of the intercepted request packet. As stated above, this is TCP if the intercepted content request is HTTP, and is UDP if the intercepted request is WAP. Parameters 808 and 810 together provide the unique subscriber identity, the first type of information element discussed above. Parameter 808 is the length of the subscriber identification field value in bytes. Parameter 810 provides the subscriber identifier, such as the mobile station ISDN number (MSISDN), in string format.

FIG. 8 further shows parameter 812 indicating entry count, that is, the number of entries in the original HTTP/WAP request. As stated above, if the original request to GGSN 104 is a pipelined HTTP request, or a concatenated WAP request, there will be one entry per requested URL. In a non-pipelined HTTP request, or a non-concatenated WAP request, there will only be one entry.

Parameters 814, 816 and 818 are parameters pertaining to each of the entry numbers in message 800. Parameter 814 indicates the type of protocol, either HTTP or WAP, used for the HTTP/WAP request for the entry received at GGSN 104 from the subscriber. Parameter 816 is the length of the URL field value in bytes, and parameter 818 is the URL at which requested content is located for the entry. Thus, parameter 818 is the second information element referred to above.

Referring to FIG. 9, there is shown the format for a Content Decision Response message 900, to be sent from Content Filter Server 110 to GGSN 104 in response to a corresponding Content Decision Request message 800. Message 900 is configured to provide a response to each individual entry in the corresponding message 800. FIG. 9 shows message 900 provided with a sequence number parameter 902 and an entry count parameter 904. Parameter 902 is used to correlate each response message with its corresponding request message. Entry count parameter 904 provides the number of entries in a Response message 900. If this value does not match the entry count in the corresponding Request message 800, then the Content Decision Response message will be discarded. When this occurs, all corresponding HTTP/WAP requests will be allowed to pass through the GGSN 104, enabling the requester to access the requested content sites.

While not shown in FIG. 9, Content Decision Response message 900 includes a common header that contains a value that may be one of two possible header code values. A first header code value will indicate that the Content Filter Server 110 was able to parse and respond to the corresponding Content Decision Request message properly. The second header code value indicates that the corresponding Content Decision Request could not be parsed properly. In this case, the Content Decision Response message will be discarded, and all corresponding HTTP/WAP requests will be allowed to pass through the GGSN 104. If any other value is found in the common header, it will be treated in the same manner as a second header code value.

Referring further to FIG. 9, it will be seen that a status code parameter 906 is provided for each entry in the corresponding Content Decision Request message 800. The parameter 906, for a given entry, will contain either a first, second, or third response code value, wherein the response code value indicates the decision of Content Filter Server 110 for the given entry. A first response code value, e.g., 200, indicates that the HTTP/WAP request corresponding to the entry, that is, the original request submitted to access a particular URL site, is allowed. Thereupon, the GSSN 104 will allow the requester to access content at the particular URL site. However, a second response code value, e.g., 403, in parameter 906 will indicate to GGSN 104 that the requester should be blocked from accessing content at the particular URL site.

A third response code value, e.g., 302, in status code parameter 906 indicates that the corresponding HTTP/WAP request is to be re-directed by GGSN 104, to a URL site different from the requested site. Accordingly, the Content Decision Request message 900 further contains parameters 908 and 910 for each entry. If an entry has a status code of the third response value, its parameter 908 will provide the length of the URL, to which the HTTP/WAP request is redirected, in bytes. The parameter 910 for such entry provides the URL for the redirection. However, the parameter 908 will be zero, and the parameter 910 will be excluded, if the status code for an entry has either a first or second response code value.

It is possible that the status code parameter for an entry could be found to have a value other than the first, second or third response code value. If this occurs, the entry will be treated as having a status code of the second response code value.

As a further feature, if the GGSN 104 times out while waiting for an Options Response message, or if there is any problem in parsing the contents of an Options Response message, the GGSN will send another Options Request message to the Content Filter Server 110. After a maximum number of attempts, the GGSN will disconnect its TCP connection to the Content Filter Server. The Options Request timeout value is configurable, and the maximum number of Options Request attempts is usefully defined to be three. Thereafter, at specified intervals GGSN 104 will send an Options Request, in a continuing effort to establish a connection with CFS 110.

If the GGSN times out waiting for a Content Decision Response message, or if there is any problem parsing the contents of the Content Decision Response message, the GGSN will treat the case as if the Content Decision Response had been received with a first response code status. Thereupon, the HTTP/WAP request will be sent along to the HTTP/WAP server gateway, allowing the requestor to access the requested content sites. The Content Decision Request timeout value will be configurable. In accordance with the protocol of the invention, Content Decision Requests are not re-transmitted.

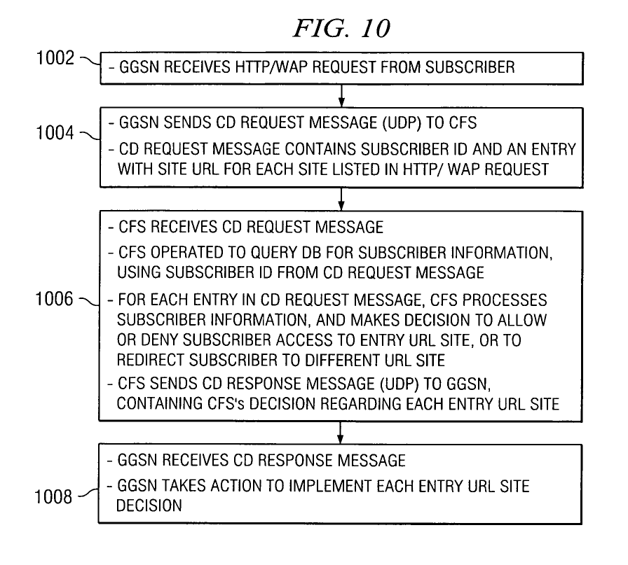

Referring to FIG. 10, there is shown a flow chart summarizing operation of the protocol described above, in regard to an HTTP/WAP request. The flow chart assumes that a connection has previously been established between GGSN 104 and CFS 110, using Options Request and Options Response messages as described above. Function block 1002 shows the HTTP/WAP request received at GGSN 104, from a subscriber or other requestor who seeks access to content at one or more URL sites listed in the HTTP/WAP request. As shown by function block 1004, upon receiving the HTTP/WAP request, GGSN 104 sends a Content Decision Request message to CFS 110, using UDP. The CD Request message includes an identifier for the subscriber or other requester, and further includes an entry with site URL for each site listed in the HTTP/WAP request. Referring to function block 1006, the CFS 110 responds to the Content Decision Request message by querying a database for subscriber information, as described above. This is carried out using the subscriber identifier, such as the identification code of a mobile phone. The subscriber information acquired from the database may indicate, for example, that the mobile phone owner is a minor, or is authorized to access certain URL sites on behalf of a business or other organization.

Function block 1006 further shows that CFS 110 uses the acquired subscriber information to make a decision in regard to each entry in the Content Decision Request message. As described above, for a given entry the decision will be either to allow or deny subscriber access to the entry URL site, or to redirect the subscriber to a different URL site. When the decision making process is completed, CFS 110 sends a Content Decision Response message to GGSN 104. This message contains the decision of CFS 110 for each URL site entry in the Content Decision Request. In accordance with function block 1008, upon receiving the Content Decision Response message, GGSN 104 is operated to implement the decision in regard to each requested URL site.

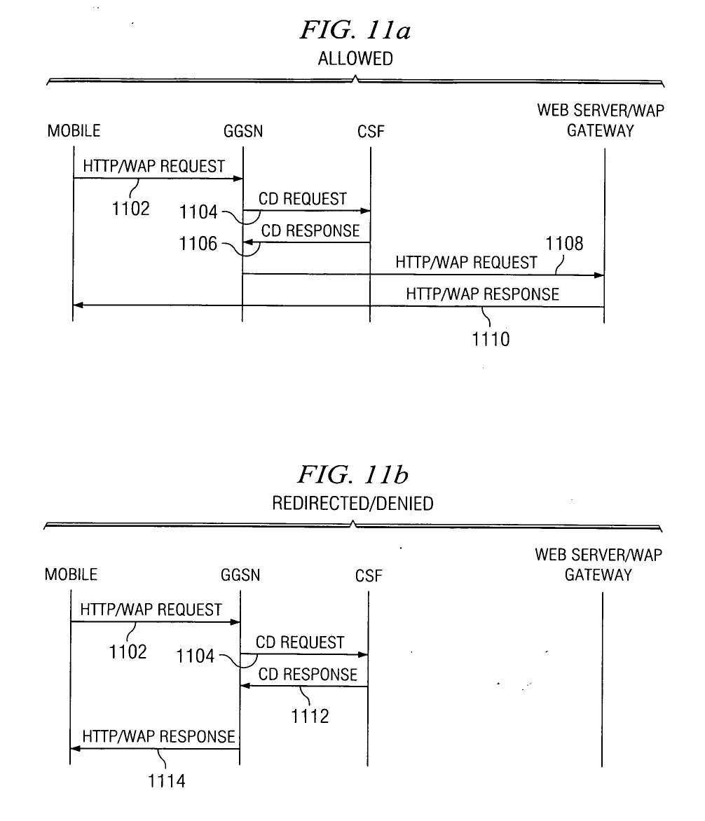

Referring to FIG. 11, there is shown two sets of sequence diagrams to further illustrate the routing of messages in an embodiment of the invention. Each diagram indicates a flow of messages between a content access requester using a mobile phone, GGSN 104, CFS 110, and a web server or WAP gateway providing access to requested sites. Diagram (a) more particularly indicates the message flow for the case in which CFS 110 renders a decision allowing access to a requested site. Diagram (b) depicts message flow for the cases in which CFS 110 either redirects or denies a site access request.

Referring further to FIG. 11, diagram (a) shows an HTTP/WAP content request message 1102 routed from the mobile phone user to GGSN 104. Thereupon, GGSN 104 sends a Content Decision Request 1104, as described above, to CFS 110. In response, CFS 110 directs a Content Decision Response 1106 back to GGSN 104, to indicate that access to the requested site is allowed. Accordingly, GGSN 104 routes the HTTP/WAP content request to the web server or WAP gateway, as indicated by message 1108. Finally, the web server or WAP gateway responds back to the mobile phone requester with a message 1110.

Diagram (b) shows the transmission of an HTTP/WAP content request message 1102 and a Content Decision request message 1104, in like manner with messages 1102 and 1104, respectively, of set (a). However, in set (b) the Content Decision Response message 1112, sent from CFS 110 to GGSN 104, indicates that the content access request is being either redirected or denied. Accordingly, GGSN 104 sends an HTTP/WAP response message 1114, to inform the content requestor of this decision.

The invention can take the form of an entirely hardware embodiment, an entirely software embodiment or an embodiment containing both hardware and software elements. In a preferred embodiment, the invention is implemented in software, which includes but is not limited to firmware, resident software, or microcode.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In association with a network having one or more sites that each contains content, wherein a requester submits a request to access one or more of the content sites, a method for content filtering comprising the steps of:
receiving a content decision request, containing one or more first information elements and a single second information element, at a Content Filter Server, wherein each of said first information elements uniquely identifies the location of one of said content sites in said request submitted by said requester, and said second element comprises an identifier uniquely identifying said requestor; and
selectively processing specified variable inputs to decide whether to allow or to deny access to said requested content sites to said requester, said specified variable inputs being limited to said one or more first information elements and to said single second information element.

2. The method of claim 1, wherein:
said processing step comprises implementing a single batch process that is respectively applied to each requested content site associated with one of said first information elements contained in said content decision request.

3. The method of claim 1, wherein:
said processing step comprises implementing a process that provides a response for each requested content site, wherein said response is selected from a group comprising first, second and third possible responses, said first response allowing said requester to access a requested site, said second response denying said requestor access to a requested site, and said third response redirecting said requester from a requested site to another site at a different location.

4. The method of claim 1, wherein:
communication in regard to said content decision request is limited to first and second message sets, said first message set comprising initializing options request and options response messages; and
said second message set comprises said content decision request, containing said first information elements, and further comprises a content decision response, containing a decision in regard to each content site that is uniquely identified by one of said first information elements.

5. The method of claim 4, further comprising:
sending said content decision request to said Content Filter Server from a node gateway located at a first location.

6. The method of claim 5, further comprising:
using first information elements that respectively comprise URLs to identify the locations of said content sites; and
said node gateway and said Content Filter each supports HTTP and WAP.

7. The method of claim 6, further comprising:
communicating messages of said first message set using TCP, and communicating messages of said second message set using UDP.

8. The method of claim 7, further comprising:
submitting said request to access one or more content sites by means of a wireless communication device.

9. The method of claim 8, wherein:
said Content Filter Server uses said requester identifier to access a subscriber database, in order to obtain additional information regarding said requester, said additional information being used in deciding whether to allow or deny access to said requested content.

10. The method of claim 9, wherein:
messages of said first and second message sets are respectively sent in accordance with a binary protocol.

11. In association with a network having one or more sites that each contains content, wherein a requester submits a request to access one or more of the content sites, a computer program product in a computer readable medium for content filtering comprising:
first instructions for sending a content decision request, containing one or more first information elements and a single second information element, from a first location to a Content Filter Server, wherein each of said first information elements uniquely identifies the location of one of said content sites in said request submitted by said requestor, and said second element comprises an identifier uniquely identifying said requestor; and
second instructions for selectively processing specified variable inputs at said Content Filter Server to decide whether to allow or to deny access to said requested content sites to said requester, said specified variable inputs being limited to said one or more first information elements and to said single second information element.

12. The computer program product of claim 11, further comprising:
third instructions for processing said variable inputs by implementing a single batch process that is respectively applied to each requested content site associated with one of said first information elements contained in said content decision request.

13. The computer program product of claim 11, further comprising:
fourth instructions for implementing a process that provides a response for each requested content site, wherein said response is selected from a group comprising first, second and third possible responses, said first response allowing said requester to access a requested site, said second response denying said requestor access to a requested site, and said third response redirecting said requester from a requested site to another site at a different location.

14. The computer program product of claim 11, wherein:
communication between said first location and said Content Filter Server in regard to said content decision request is limited to first and second message sets, said first message set comprising initializing options request and options response messages sent between said first location and said Content Filter Server; and
said second message set comprises said content decision request, containing said first information elements and sent from said first location to said Content Filter Server, and further comprises a content decision response, sent back to said first location from said Content Filter Server and containing a decision in regard to each content site that is uniquely identified by one of said first information elements.

15. The computer program product of claim 11, wherein:
said Content Filter Server uses said requestor identifier to access a subscriber database, in order to obtain additional information regarding said requester, said additional information being used in deciding whether to allow or deny access to said requested content.

16. In association with a network having one or more sites that each contains content, wherein a requester submits a request to access one or more of the content sites, a system for content filtering comprising:
a node gateway configured to send a content decision request, containing one or more first information elements and a single second information element, from a first location to a second location, wherein each of said first information elements uniquely identifies the location of one of said content sites in said request submitted by said requestor, and said second element comprises an identifier uniquely identifying said requester; and
a Content Filter Server at said second location for receiving said content decision request and selectively processing specified variable inputs to decide whether to allow or to deny access to said requested content sites to said requestor, said specified variable inputs being limited to said one or more first information elements and to said single second information element.

17. The system of claim 16, wherein:
said Content Filter Server implements a single batch process that is respectively applied to each requested content site associated with one of said first information elements contained in said content decision request.

18. The system of claim 16, wherein:
said Content Filter Server implements a process that provides a response for each requested content site, wherein said response is selected from a group comprising first, second and third possible responses, said first response allowing said requestor to access a requested site, said second response denying said requestor access to a requested site, and said third response redirecting said requestor from a requested site to another site at a different location.

19. The system of claim 16, wherein:
communication between said node gateway and said Content Filter Server in regard to said content decision request is limited to first and second message sets, said first message set comprising initializing options request and options response messages sent between said first location and said Content Filter Server; and
said second message set comprises said content decision request containing said first information elements and sent from said first location to said Content Filter Server, and further comprises a content decision response, sent back to said first location from said Content Filter Server and containing a decision in regard to each content site that is uniquely identified by one of said first information elements.

20. The system of claim 16, wherein:
said Content Filter Server uses said requester identifier to access a subscriber database, in order to obtain additional information regarding said requester, said additional information being used in deciding whether to allow or deny access to said requested content.
